(19) United States
(12) Patent Application Publication
(10) Pub. No.: US 2012/0025101 A1
(43) Pub. Date: Feb. 2, 2012

(54) METHOD OF DECOMPOSING CONSTITUENTS OF A TEST SAMPLE AND ESTIMATING FLUORESCENCE LIFETIME

(75) Inventors: Guobin Ma, Dorval (CA); Mario KHAYAT, Montreal (CA)

(73) Assignee: ART ADVANCED RESEARCH TECHNOLOGIES INC., Saint-Laurent (CA)

(21) Appl. No.: 13/270,884

(22) Filed: Oct. 11, 2011

Related U.S. Application Data
(63) Continuation of application No. 12/355,270, filed on Jan. 16, 2009, now abandoned.
(60) Provisional application No. 61/036,697, filed on Mar. 14, 2008.
(60) Provisional application No. 61/022,103, filed on Jan. 18, 2008.

(51) Int. Cl. G01J 1/58

(52) U.S. Cl. 250/459.1

(57) ABSTRACT

The present invention relates to a method of decomposition of a test sample into constituents thereof. The method proceeds by optically imaging the test sample to obtain a corresponding unknown time-domain resolved signal and decomposes the unknown time-domain resolved signal by comparing the unknown time-domain resolved signal with time-domain resolved reference signals. Furthermore, the method allows the determination of the presence or absence of constituents. Relative quantities may also be determined if sample material properties are known or taken into account. Lifetime decay of the constituents may also be estimated by handling effect of light diffusion in the test sample as time decay.

### FIELD OF THE INVENTION

This invention relates generally to the field of optical imaging of biological tissue and, more specifically, to decomposing of constituents of a test sample and corresponding fluorescence lifetime.

### BACKGROUND OF THE INVENTION

Recent advancement and increased commercial availability for small animal diffuse optical molecular imagers have provided significant benefits to the molecular biology community. The use of specific fluorescent markers (e.g., cyanine dyes, reporter genes such as green fluorescent protein (GFP) and mutated allelic forms such as yellow and red fluorescent protein (YFP, RFP)) enables in vivo studies of cellular and molecular processes. Among the advantages associated with optical imaging methods are the small numbers of animals required per study (because of the innocuous nature of the technology), the significant sensitivity and specificity, and the ease of combining fluorescent markers with specifically targeted probes.

Fluorescence imaging often involves the injection of an extrinsic fluorophore, typically chemically bounded with drug molecules or activated after interaction with specific enzymes. An external light source is applied to excite the fluorophore and the fluorescent signal is recorded accordingly. A common issue encountered in practical application is interference from the background signal, which is the inherent signal detected by an imaging device when target fluorescent material is absent. In general, a background signal originates from four sources: auto-fluorescence within a tissue sample (critical in spectral region of visible light), residual signal due to imperfect clearance of the targeted probe, leakage of the excitation laser light due to imperfect fluorescent filters, and fluorescence from the optical components within the signal acquisition channel. Various techniques can be employed to reduce the background signal, but it cannot be completely eliminated.

Fluorescence lifetime is an intrinsic character of a fluorophore. In fluorescence lifetime imaging, lifetimes are measured at each pixel and displayed as contrast. In other words, fluorescence lifetime imaging combines the advantages of lifetime spectroscopy with fluorescence spectroscopy. In this way an extra dimension of information is obtained. This extra dimension can be used to discriminate among multiple labels on the basis of lifetime as well as spectra. This allows more labels to be discriminated simultaneously than by spectra alone in applications where multiple labels are required.

In addition, fluorescence lifetime measurements can yield information on the molecular microenvironment of a fluorescent molecule. Factors such as ionic strength, hydrophobicity, oxygen concentration, binding to macromolecules and the proximity of molecules that can deplete the excited state by resonance energy transfer and can all modify the lifetime of the fluorophore. Measurements of lifetime can therefore be used as indicators of these parameters. In in vivo studies, these parameters can provide valuable diagnostic information relating to the functional status of diseases. Furthermore, these measurements are generally absolute, being independent of the concentration of the fluorophore. This can have considerable practical advantages. For example, the intracellular concentrations of a variety of ions can be measured in vivo by fluorescence lifetime techniques. Many popular, visible wavelength calcium indicators, such as Calcium Green 1, give changes of fluorescence intensity upon binding calcium. The intensity-based calibration of these indicators is difficult and prone to errors. However, many dyes exhibit useful lifetime changes on calcium binding and therefore can be used with lifetime measurements.

Estimating lifetime is essential for many aforementioned applications, e.g, differentiating different fluorophores, as well as the same fluorophore in free or bounding states, or in different microenvironments. If there exists more than one fluorophore or the same fluorophore in different states (bounded with other molecules or free) in the testing sample, estimating the fraction of each constituent in the mixture is same important. For example, the ratio between bound and free, or the ratio between targeted and background, is determined by the fraction contribution.

For systems equipped with time-domain (TD) technology, the measured fluorescence signal emanating from bulk tissues can be modeled by the convolution of fluorescence decays, system impulse response function (IRF), and model expressions for light transport of excitation as well as fluorescence photons. To precisely recover fluorescence lifetimes and the fraction of each constituent, one needs to employ complex light propagation models (e.g., the radiative transfer equation or a simpler yet consistent approximate equation such as the diffusion equation) requiring knowledge of the tissue optical properties. However, this can be computationally expensive and therefore not practical in many applications.

### SUMMARY OF THE INVENTION

In accordance with a first aspect, a method is provided for decomposing one or a plurality of constituents of a test sample using time-resolved reference signals. Time-resolved reference signals produced by various constituents in a reference sample are obtained by measuring the time-resolved signal of each constituent individually or in sub-groups using a time-domain optical imaging apparatus. An unknown time-resolved signal corresponding to an in vivo test sample is recorded by the optical time-domain imaging apparatus. Using the time-resolved reference signals, the unknown time-resolved signal is decomposed so as to determine presence of the one or plurality of constituents—a qualitative analysis, and further identifying relative fractional contributions of the constituents—a quantitative analysis.

In a particular aspect, the constituents are two fluorophores, and the time-resolved reference signals correspond to the measured time-resolved signal for each of the two different fluorophores in the reference sample. Alternatively, one of the constituents may be a fluorophore and the other constituent relate to autofluorescence of a medium, such as a tissue, into which the fluorophore is injected.

In accordance with a particular aspect, the decomposing of the unknown time-resolved signal of the test sample may be done using a linear least squares fitting to the time-resolved reference signals. These time-resolved signals may further be normalized by their steady-state intensity, so that a relative contribution of each of the corresponding constituent is determined.

In a particular aspect, the quantitative analysis may involve locating the constituents at a same position in the reference samples and the test sample. If the constituents have different known locations, a relative quantitative analysis may involve using light propagation theory to compensate for diffusion effects. In the particular case of fluorescent constituents, by measuring the steady state fluorescence ratio of multiple fluorescent constituents, given an identical quantity of each, a constituent quantity fraction may be determined from its estimated reference signal intensity fraction.

In accordance with another aspect, the present invention further takes under consideration for fluorescent constituents estimation of the fluorescence lifetimes of multiple fluorophores embedded in the test sample. In a first aspect, by assuming that photon diffusion does not significantly change the fluorescence decay slope, the light propagation is modeled as a time-delay during lifetime estimation. Then the fluorescence lifetimes are estimated by comparing relative fractional contribution of the constituent in the unknown time-resolved sample to the convolution of an impulse response function system with fluorescence decay model. In a second aspect, the fraction of each fluorescent constituent in a mixture is obtained by comparing unknown time-resolved signal with time-resolved reference signals corresponding to each constituent.

### BRIEF DESCRIPTION OF THE DRAWINGS

FIG. 1 is a schematic view of an optical imaging system that may be used with the present invention.

FIG. 2 is a series of fluorescence signal images resulting from the measurement of test samples having different relative ratios of known fluorescing constituents.

FIG. 3 is a graphical depiction of the temporal signatures of three different constituents each of which is present in one or more of the test samples of FIG. 2.

FIG. 4 is a graphical depiction of a decomposition fitting of a time-resolved signal from one of the test samples of FIG. 2 using the three constituents of the sample, as shown in FIG. 3, along with the fitting error.

FIG. 5 is a graphical depiction of a decomposition fitting, along with the fitting error, of a two constituent test sample of FIG. 2 using the two time-resolved reference signals for the corresponding constituents.

FIGS. 6A and 6B are graphical depictions, respectively, of a time-resolved fluorophore signal from organic tissue from which a background fluorescence signal constituent has been removed, and the corresponding background signal.

FIGS. 7A and 7B are graphical depictions of two examples of the decomposition of unknown fluorescence signals using the reference fluorophore signal and the background signal of FIGS. 6A and 6B, the figures each showing the relevant fitting and corresponding fitting error.

FIG. 8A is a raw fluorescence intensity image for a sample having multiple constituents.

FIG. 8B is a set of intensity images for the fitted fractions corresponding to the intensity signal of FIG. 8A.

FIG. 9 is a graphical depiction of the time scales related to fluorescence decay, light diffusion in tissue, and system IRF for typical fluorescence spectroscopy using reflection configuration.

FIG. 10 is a graphical view of examples of dual lifetime fitting of fluorescence signals from biological tissue.

FIG. 11 is a graphical view of examples of recovering the constituent fractions of fluorophore mixtures in tissue.

FIG. 12 is a graphical depiction of examples of dual lifetime fitting of fluorescence signal from tissue-like medium based on phantom data.

FIG. 13 is a graphical depiction of examples of recovering the constituent fractions of fluorophore mixtures in tissue-like medium by signals from single dyes based on phantom data.

FIG. 14 shows an intensity image of a mouse injected with various fluorescence dyes.

FIG. 15 is a graphical depiction of dual lifetime fitting of the fluorescence signal from the upper-left spot of the mouse shown in FIG. 14.

FIG. 16 is a graphical depiction of a fitted constituent fraction of the dye mixture injected in the upper-left spot of the mouse shown in FIG. 14.

### DETAILED DESCRIPTION OF THE INVENTION

### Time-Domain Optical Imaging Apparatus

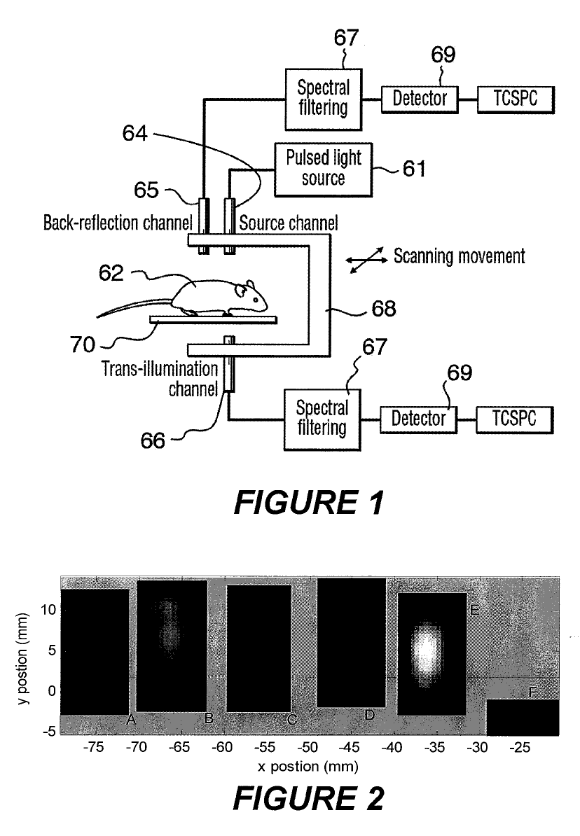

Shown in FIG. 1 is time-domain optical imaging apparatus that may be used with the method of the present invention. Systems such as this are known in the art, and other configurations may also make use of the invention. In the arrangement of FIG. 1, source 61 provides light. The light is directed towards a predetermined point of light injection on object 62 using source channel 64. The source channel 64 is an optical means for directing the light to the desired point on the object 62 and may include a fiber optic, reflective mirrors, lenses and the like. A first detector channel 65 is positioned to detect emission light in a back-reflection geometry and a second detector channel 66 is positioned in a trans-illumination geometry. The detector channels 65 and 66 are optical means for collecting the emission light from desired points on object 62 and are optically coupled to photon detector 69. As with the source channel 64, the detector channels 65 and 66 may include a fiber optic, lenses, reflective mirrors and the like. The source 64 and detector channels 65 and 66 may operate in a contact or free space optic configuration. By contact configuration it is meant that one or more of the components of the source and/or detector channel is in contact with object 62. In contrast, a free space optic configuration means that light is propagated through air and directed to or collected from the desired points with appropriate optical components. If desired, the detector channels 65 and 66 can be coupled to spectral filters 67 to selectively detect one or a bandwidth of wavelengths.

The source 64 and detector channels 65 and 66 can be physically mounted on a common gantry 68 so as to maintain them in a fixed relative position. In such an arrangement, the position of the point of injection of light and that of the point from which the emission light is collected can be selected by moving (scanning) the gantry 68 relative to the object 62. Alternatively, relative positioning of the object 62 and the source/detector channels 64, 65 and 66 may be accomplished by moving the object 62 relative to the gantry 68, or the combination of the movement of the two.

The position of the source and detector channels 64, 65 and 66 may also be controlled independently from one another. It will be appreciated that the position of the back-reflection and trans-illumination detector channels 65 and 66 can also be independently controlled. Furthermore, the apparatus may also allow a combination of arrangements. For example, the trans-illumination channel may be in a fixed position relative to the source channel whereas the position of the back reflection channel is controlled independently. The favored arrangement may depend on the type of object 62 being probed, the nature and/or distribution of fluorophore(s) in the object and the like.

The object 62, in this case a mouse, can be placed on a transparent platform 70 or can be suspended in the desired orientation by providing attachment means (not shown) and an appropriate structure within the apparatus. In this example, the position of the platform or the attachment means can be adjusted along all three spatial coordinates. In the trans-illumination geometry the thickness of the object is preferably determined to provide a value for the optical path (source to point of interest rₛₚ+point of interest to detector r_{pd}). If the channels are in a contact configuration the thickness may be provided by the distance between the source channel at the point of light injection and the trans-illumination detector channel at the point of light collection. In the case of a free space optic configuration the thickness may advantageously be provided by a profilometer which can accurately determine the coordinates of the contour of the object.

The source 61 may consist of a plurality of sources operating at different wavelengths. Alternatively, the source 61 may be a broadband source optically coupled to a spectral filter (not shown) to select appropriate wavelength(s). The wavelengths can be de-multiplexed into individual wavelengths by the spectral filter 67. Selection of wavelength may also be effected using other appropriate optical components such as prisms. In general, the apparatus shown in FIG. 1 is an example of a time-domain optical imaging apparatus that may be used with the present invention. However, those skilled in the art will understand that the invention may be implemented using other systems or apparatuses as well.

### Decomposition of Constituents

One main challenge of data processing in vivo fluorescence imaging is to separate target fluorescence from multiple fluorescents and/or one or multiple fluorescents from autofluorescence—also called unwanted background noise. Usually in optical imaging, some knowledge of the object being imaged generally exists. For example, when a highly concentrated GFP labeled tumor tissue is optically imaged, a resulting time-resolved signal is composed mainly of GFP fluorescence. In contrast, if a mouse without injected fluorescent protein is optically imaged, the resulting time-resolved signal corresponds to background noise. In many situations, the resulting time-resolved signal is a combination of GFP and background noise. The characterization of background noise in such resulting time-resolved signal is not a trivial task. And unfortunately, there are multiple sources of background noise in optical imaging: leakage of excitation laser light due to imperfect fluorescent filters, fluorescence from optical constituents within a signal acquisition channel, and tissue autofluorescence. Tissue autofluorescence may be contributed by several endogenous fluorophores such as aromatic amino acids (e.g., tryptophan, tyrosine, phenylalanine), structural proteins (e.g., collagen, elastin), nicotiamide adenine dinucleotide (NADH), flavin adenine dinucleotide (FAD), porphyrins, lipopigments (e.g., ceroids, lipofuscin), and other biological constituents.

To overcome the problem of autofluorescence, prior art methods have identified autofluorescence using its spectral signature, which is possible only when the emission band of the autofluorescence is not highly overlapped with the spectral signature of the target fluorescence.

### Method of Decomposing

The present invention proposes a novel method to separate one or a plurality of constituents of a test sample based on their temporal signatures. For doing so, temporal signature of the one or plurality of constituents are obtained separately, concurrently or in sub-groups by performing an optical imaging of the one or plurality of constituents in a reference sample so as to collect corresponding time-resolved reference signals. The time-resolved reference signals are then used to decouple constituents of the test sample in the time domain. The first aspect of decomposing is the qualitative analysis. The qualitative analysis determines the presence or absence of each of the constituents in the test sample. The second aspect of decomposing is the quantitative analysis. The quantitative analysis determines the relative fractional contribution of each constituent in the test sample. Some applications may require only the qualitative analysis, while other will require the quantitative analysis. It will be apparent to those skilled in the art that the quantitative analysis is more computationally heavy than the qualitative analysis.

The expression “constituent” is being used throughout the present application, and is meant to represent all of the following: target fluorescence, autofluorescence and all other related constituents, which can be optically imaged, and have a temporal signature.

In time domain, a measured fluorescence signal F₀(t) can be written as a sum of several decay curves over time

F₀(t)=ΣᵢF_{0,i}(t), Eq. (1)

where F_{0,i}(t) can be a single exponential decay profile, or a combination of multiple exponential decay profiles. For the case of a single exponential decay, the profile is related to the lifetime of a fluorophore, τᵢ, and its other characteristics, e.g., quantum yield, extinction coefficient, concentration, volume, excitation and emission spectra. In addition, the temporal profile of an excitation laser pulse and the system impulse response function (IRF), S(t), also contribute to the measured signal. Mathematically, the measured signal can be modeled as the following convolution

F(t)=F₀(t)*S(t). Eq. (2)

Furthermore, if fluorophores are embedded inside a bulk tissue or turbid medium, there will be two more terms contributing to the convolution: the propagation of excitation light from source to fluorophore, H(\vec{r}ₛ−\vec{r}_{f},t), and the propagation of fluorescent light from fluorophore to detector E(\vec{r}_{f}−\vec{r}_{d},t), such that

F(t)=H(\vec{r}ₛ−\vec{r}_{f},t)*F₀(t)*E(\vec{r}_{f}−\vec{r}_{d},t)*S(t), Eq. (3)

where \vec{r}ₛ, \vec{r}_{f}, \vec{r}_{d} and are the coordinates of light injection point on the tissue, fluorophore inside the tissue, and light detecting point on the tissue, respectively.

To precisely model the fluorescence signal, all terms in the convolution need to be accounted for. The propagation of visible and infrared photons in tissue is a diffusive process, which can be modeled using the diffusion equation (DE). Using the term D(\vec{r},t) to represent the diffusion term D(\vec{r},t)=H(\vec{r}ₛ−\vec{r}_{f},t)*E\vec{r}_{f}−\vec{r}_{d},t) F(t) may be represented as follows:

F(t)=F₀(t)*D(\vec{r},t)*S(t). Eq. (4)

In the following example, a fluorescence signal consists of two constituents. Equation (1) may therefore be rewritten as:

F₀(t)=F_{0,1}(t)+F_{0,2}(t) Eq.(5)

If the signal constituents are from bulk tissue, the individual signal constituents, according to equation (4), may be expressed as follows:

F₁(t)=F_{0,1}(t)*D(\vec{r}₁,t)*S(t) Eq. (6a)

and

F₂(t)=F_{0,2}(t)*D(\vec{r}₂,t)*S(t) Eq. (6b)

the corresponding steady-state intensities are,

Iᵢ=∫Fᵢ(t)dt=∫[F_{0,i}(t)*D(\vec{r}ᵢ,t)*S(t)]dt. Eq.(7)

Using the property of convolution, by which the area under a convolution is the product of areas under the factors, equation (7) may be rewritten as:

Iᵢ=[∫F_{0,i}(t)dt]·[∫D(\vec{r}ᵢ,t)dt]·[∫S(t)dt],

or

Iᵢ=I_{0,i}·D(\vec{r}ᵢ)·∫S(t)dt Eq.(8)

where I_{0,i}=∫F_{0,i}(t)dt, and D(\vec{r}ᵢ)=∫D(\vec{r}ᵢ,t)dt.
The total steady-state intensity of the fluorescence signal can be obtained similarly:

I=I₀·D(\vec{r})·∫S(t)dt, Eq.(9)

where I₀=∫F₀(t) dt, and D(\vec{r})=∫D(r,t)dt.

If the two fluorescence signals F₁(t) and F₂(t) are normalized by their steady-state intensities, then the normalized signals F₁⁽ⁿ⁾(t) and F₂⁽ⁿ⁾(t) are:

$${F}_{i}^{( n )} ( t ) = \frac{{F}_{i} ( t )}{{I}_{i}} = \frac{{F}_{0 , i} ( t )}{{I}_{0 , i}} * \frac{D ( {\vec{r}}_{i} , t )}{D ( {\vec{r}}_{i} )} * \frac{S ( t )}{{\int }_{ }^{ } S ( t ) d t} \qquad Eq . ( 10 )$$

Similarly, the normalized signal of the combined F⁽ⁿ⁾(t) is:

$${F}^{( n )} ( t ) = \frac{F ( t )}{I} = \frac{{I}_{1 , 0} D ( {\vec{r}}_{1} )}{{I}_{0} D ( \vec{r} )} \cdot \frac{{F}_{1 , 0} ( t )}{{I}_{1}} * \frac{D ( {\vec{r}}_{1} , t )}{D ( {\vec{r}}_{1} )} * \frac{S ( t )}{{\int }_{ }^{ } S ( t ) d t} + \frac{{I}_{2 , 0} D ( {\vec{r}}_{2} )}{{I}_{0} D ( \vec{r} )} \cdot \frac{{F}_{2 , 0} ( t )}{{I}_{2}} * \frac{D ( {\vec{r}}_{2} , t )}{D ( {\vec{r}}_{2} )} * \frac{S ( t )}{{\int }_{ }^{ } S ( t ) d t} \qquad Eq . ( 11 )$$

which leads to

F⁽ⁿ⁾(t)=f₁′·F₁⁽ⁿ⁾(t)+f₂′·F₂⁽ⁿ⁾(t). Eq. (12)

Equation (12) can be extended to multiple constituents

F⁽ⁿ⁾(t)=Σᵢfᵢ′·Fᵢ⁽ⁿ⁾(t) Eq. (13)

where

$${f}_{i}^{′} = \frac{{I}_{i , 0} D ( {\vec{r}}_{i} )}{{I}_{0} D ( \vec{r} )} \qquad Eq . ( 14 )$$

is the “pseudo” fractional contribution of the i^{th} constituent, since it contains terms not only related to the fluorescence signal but also to the diffusion effect.

As an immediate application, Equation (12) can be run through a data fitting procedure to decompose an unknown time-resolved signal F(t) into two known constituents, F₁(t) and F₂(t). Even if there is no prior knowledge of the location and quantity of either F(t) or F₁(t) and F₂(t) (as is true in many practical applications), Equation (12) may still be used to decompose F(t) into F₁(t) and F₂(t). In such a case, since D(\vec{r}) and D(\vec{r}ᵢ) are not known, the fitted pseudo fraction can be used to determine the presence of F₁(t) or F₂(t) constituents within F(t). In practice, one may also define a threshold to account for the error related to experimental conditions and data analysis in order to properly qualify the contribution of each constituent. If the fitted fᵢ′ is larger than the threshold, it determines that the measured signal contains the i^{th} constituent. If fᵢ′ is smaller than the threshold, there is no i^{th} constituent in the measured signal.

The i^{th} constituent can be either single fluorescence decay or a combination of multiple fluorescence decays. For example, in an in vivo GFP experiment, F₁(t) can be a pure GFP fluorescence signal that is typically a single exponential decay, and F₂(t) can be a background signal that is typically a multi-exponential decay. By fitting an unknown time-resolved signal F(t) corresponding to a test sample according to equation (12), it is possible to determine whether there is a GFP constituent in F(t) even when no information about the location and number of GFP cells corresponding to F₁(t) and F₂(t), or F(t), is given. Similarly, F(t) can be decomposed into multiple constituents using equation (13).

There are at least two advantages for this approach. First, since the decomposition using equation (12), or its general form according to equation (13), is based on signals normalized by the corresponding steady-state signal intensity, it circumvents any concerns related to signal amplitude. This results in great experimental convenience because it is usually quite challenging to get proper signal amplitude that depends on many parameters, such as fluorophore quantity and location, excitation laser power, data collection time, etc. A second advantage is that no other a priori information (e.g., tissue optical properties, fluorophore information, etc.) is required except the time-resolved reference signals Fᵢ(t).

Within the scope of the invention is a particular case that merits special attention, that being when all of the fluorescence signals come from the same or similar location in the tissue. In this circumstance, D(\vec{r})=D(\vec{r}ᵢ), so that equation (14) becomes

$${f}_{1} = \frac{{I}_{i , 0}}{{I}_{0}} . \qquad Eq . ( 15 )$$

If the i^{th} constituent corresponds to a single exponential decay, then

$${F}_{0 , i} ( t ) = {A}_{i} exp ( - \frac{t}{{τ}_{i}} ) . \qquad Eq . ( 16 )$$

Consequently, I_{0,i}, =Aᵢτᵢ and I₀=ΣᵢAᵢτᵢ Inserting them into equation (15) leads to the regular definition of fractional contribution of the i^{th} constituent to the steady-state intensity of a mixed signal

$$\begin{matrix}{f}_{i} = \frac{{A}_{i} {τ}_{i}}{{\sum }_{j} {A}_{j} {τ}_{j}} = \frac{{α}_{i} {τ}_{i}}{{\sum }_{j} {α}_{j} {τ}_{j}} , \\ where & Eq . ( 17 ) \\ {α}_{i} = \frac{{A}_{i}}{{\sum }_{k} {A}_{k}} & Eq . ( 18 )\end{matrix}$$

is the relative amplitude of the i^{th} constituent.

It is possible that the i^{th} constituent is itself a combination of multi-fluorescence decay profiles. In such a case, equation (17) becomes

$${f}_{i} = \frac{{\sum }_{k} {A}_{k} {τ}_{k}}{{\sum }_{j} {A}_{j} {τ}_{j}} \qquad Eq . ( 19 )$$

Therefore, from the definition of fᵢ from either equation (17) or equation (19), the fractional contribution fᵢ of the i^{th} constituent to an unknown measured signal F(t) can be obtained through data fitting using equation (12) or equation (13) with known constituents Fᵢ(t). fᵢ is a quantity usually determined through fluorescence lifetime fitting.

However, no fluorescence lifetime is involved in the present method. The only required information is the time-resolved reference signals for constituents Fᵢ(t). This is particularly convenient, especially when one of the reference constituents itself is a combination of multiple fluorescence decay profiles. For example, the background signal during an in vivo GFP experiment usually contains four or five lifetime constituents. In that case, precisely fitting each of the lifetimes is impossible. As a result, to decouple a GFP fluorescence signal of interest is very difficult. In contrast, if the present method is used, all of the constituents contained in the background are treated as a one constituent, which can be acquired from a control specimen (e.g., a mouse). This time-resolved signal from background noise and the time-resolved reference signal for GFP (obtained from a mouse containing a large number of GFP labeled cells) then become the only two constituents of the test sample, F(t). When F(t) is fitted according to equation (12), there is only one free parameter, considering that f₁+f₂=1. The resulting fitting is robust, reliable and accurate, which is also the case if F(t) is decomposed into multiple constituents.

Another way to quantitatively obtain the fractional contribution fᵢ to the i^{th} constituent of an unknown time-resolved signal F(t) is to compute D(\vec{r}) and D(\vec{r}ᵢ) in equation (14), if F(t) is a combination of fluorescence constituents coming from different locations inside tissue. This type of application requires additional information, such as tissue optical properties and spatial distribution of the constituents, so it may be challenging in practice and less attractive for certain in vivo applications.

The present method thus relies on the fact that the fractional contribution fᵢ of the constituent i to the measured fluorescence signal intensity is proportional to the fractional quantity of the i^{th} fluorophore, Cᵢ. However, in general fᵢ≠Cᵢ due to the differences in the intrinsic characteristics of constituents, such as quantum yield, extinction coefficient, spectrum, etc. These intrinsic parameters are usually supplied by manufacturers and are applicable within specific experimental conditions. In practice, these experimental conditions are seldom exactly matched during actual optical imaging environments. Additionally, these parameters may change according to the constituent's microenvironment. Precisely measure of these intrinsic parameters is another challenge. Fortunately, it is possible to precisely relate the intensity fraction fᵢ to the quantity fraction Cᵢ without directly using any information related to the constituent's intrinsic optical properties. It can be proven that fᵢ and Cᵢ satisfy the following equations:

$$\begin{matrix}{f}_{1} = \frac{{C}_{1}}{{C}_{1} + {\sum }_{i \neq 1} {C}_{i} \cdot {r}_{i 1}} , and {f}_{i \neq 1} = \frac{{C}_{1} \cdot {r}_{i 1}}{{C}_{1} + {\sum }_{i \neq 1} {C}_{i} \cdot {r}_{i 1}} \\ where & Eq . ( 20 ) \\ {r}_{i 1} = \frac{{I}_{i , 0}}{{I}_{1 , 0}} = \frac{ɛ k {Q}_{i}}{ɛ {kQ}_{1}} \cdot \frac{{τ}_{i}}{{τ}_{1}} & Eq . ( 21 )\end{matrix}$$

is the steady-state fluorescence intensity ratio of the i^{th} constituent to the first constituent with the same quantity under the experimental condition. In equation (21), εkQᵢ represents fluorescing efficiency of the i^{th} constituent, which is related to its molar extinction coefficient, εᵢ(λ), quantum yield, Qᵢ(λ), excitation and emission spectrum as well as the excitation laser wavelength, kᵢ(λ). According to equation (20) and equation (21), with measured rᵢ₁, it becomes possible to compute the constituent quantity fraction Cᵢ in a mixture once the intensity fraction fᵢ is ready:

$${C}_{1} = \frac{1}{1 + {\sum }_{i = 2}^{n} \frac{{f}_{i}}{{r}_{i 1} ( 1 - {\sum }_{i = 2}^{n} {f}_{i} )}} , and \\ {C}_{i} = \frac{{f}_{i} \cdot {C}_{1}}{{r}_{i 1} ( 1 - {\sum }_{i = 2}^{n} {f}_{1} )} . \qquad Eq . ( 22 )$$

### Fluorescence Lifetime Estimation

In addition to performing the previously described qualitative and quantitative analysis, it is also possible to estimate the fluorescence lifetime of the constituents. The propagation of visible and infrared photons in tissue is a diffusive process that is modeled using a radiative transfer equation (RTE). Under some conditions, RTE can be approximated to diffusion equation (DE). Under diffusion approximation, the excitation photon propagation term H(\vec{r}ₛ−\vec{r}_{f},t) for a time-domain measurement with an impulse point source of light in a homogeneous slab medium is represented by the following equation:

$$H ( x , y , z , t ) = \frac{v exp ( - {μ}_{a} vt - \frac{{x}^{2} + {y}^{2}}{4 Dvt} )}{4 {π ( 4 π Dvt )}^{3 / 2}} \{ {\sum }_{m = - ∞}^{m = + ∞} exp [ - \frac{{( z - {z}_{+ , m} )}^{2}}{4 Dvt} ] - {\sum }_{m = - ∞}^{m = + ∞} exp [ - \frac{{( z - {z}_{- , m} )}^{2}}{4 Dvt} ] \} \qquad Eq . ( 23 )$$

This is the photon fluence at position \vec{r}_{f}=(x,y,z) and time, generated by a point source of unitary amplitude at position \vec{r}ₛ=(0,0,0); D=ν/(3 μs′) is the photon diffusion coefficient; μₛ′ is the reduced scattering coefficient; μₐ is the absorption coefficient; and ν is the speed of light in the medium or tissue. To satisfy the extrapolated boundary condition, the method of images is used. The positions of the image sources are at (0,0,z_{-,m}) and (0,0,z_{+,m}) with

z_{+,m}=2m(s+2z_{b})+z₀

z_{-,m}=2m(s+2z_{b})−2z_{b}−z₀′ Eq. (24)

where s is the slab thickness,

$${z}_{b} = \frac{1 + {R}_{eff}}{1 - {R}_{eff}} 2 D$$

is the distance between the medium surface and the extrapolated boundary where the photon fluence equals to zero, and R_{eff} is the internal reflectance due to refraction index mismatch between the air and the medium that can be computed using the Fresnel equation. In order to model a highly directional beam (e.g., a laser) by diffusion approximation, an isotropic source located at z₀=1/μₛ′ is assumed. That is the origin of z₀ in Eq. (24).

The fluorescence photon propagation term E(\vec{r}_{f}−\vec{r}_{d},t) has a form similar to H(\vec{r}ₛ−\vec{r}_{f},t). Obviously, H(\vec{r}−\vec{r}_{f},t) and E(\vec{r}_{f}−\vec{r}_{d},t) are complicated, which makes the nonlinear multi-parameter fitting of Equation (3) computationally heavy. Furthermore, to compute H(\vec{r}ₛ−\vec{r}_{f},t) and E(\vec{r}_{f}−\vec{r}_{d},t) requires optical properties (μₐ, μₛ′, etc.) of the tissue and the spatial information of the constituents. The information is usually not available in practical applications. Therefore precisely fitting of Equation (3) to get the fluorescence lifetimes of the constituents is a difficult task if all the related parameters are precisely taken into account.

Fortunately, for fluorescence signals from small volumes of biological tissues, such as for example a small mammal (e.g., a mouse), the light diffusion due to photon propagation, H(\vec{r}ₛ−\vec{r}_{f},t) and E(\vec{r}_{f}−\vec{r}_{d},t), does not significantly change the shape of the temporal profile of a constituent, although it changes the peak position of fluorescence decay curve, depending on tissue optical properties and the position of the constituent inside the tissue.

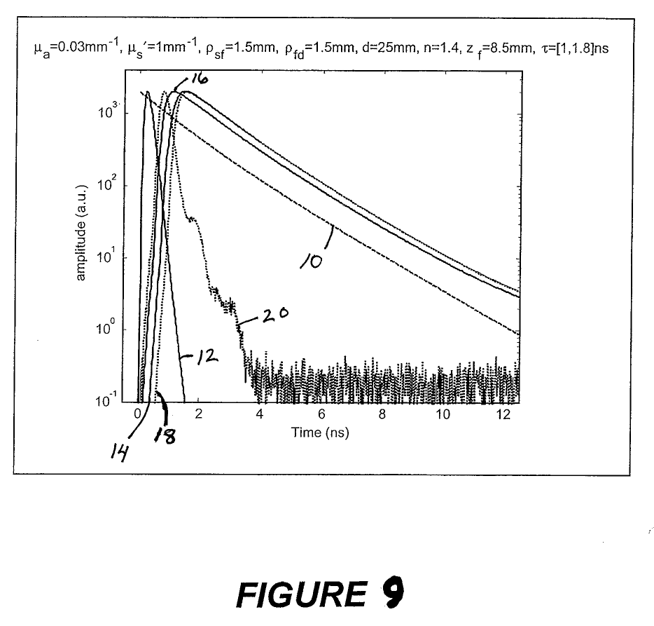

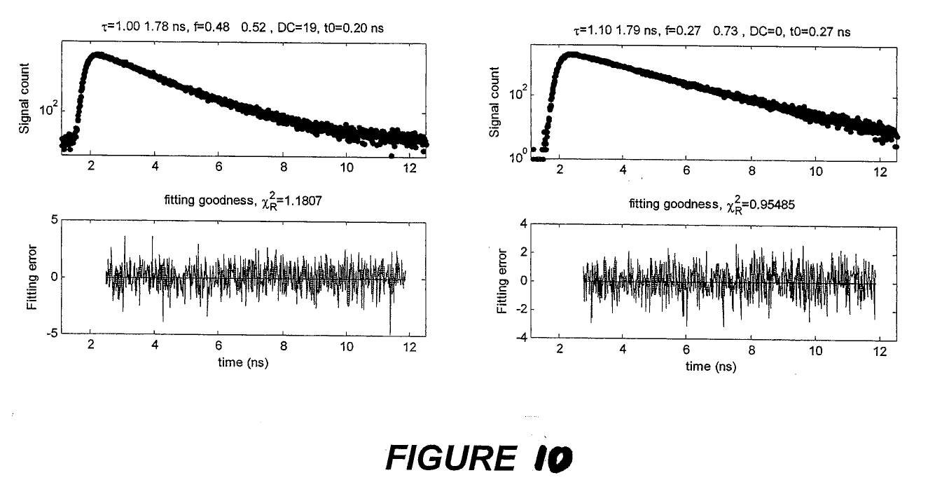

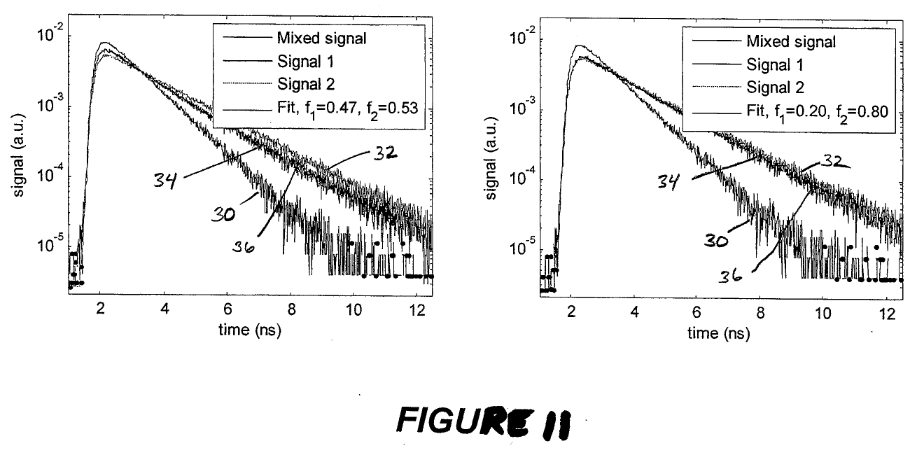

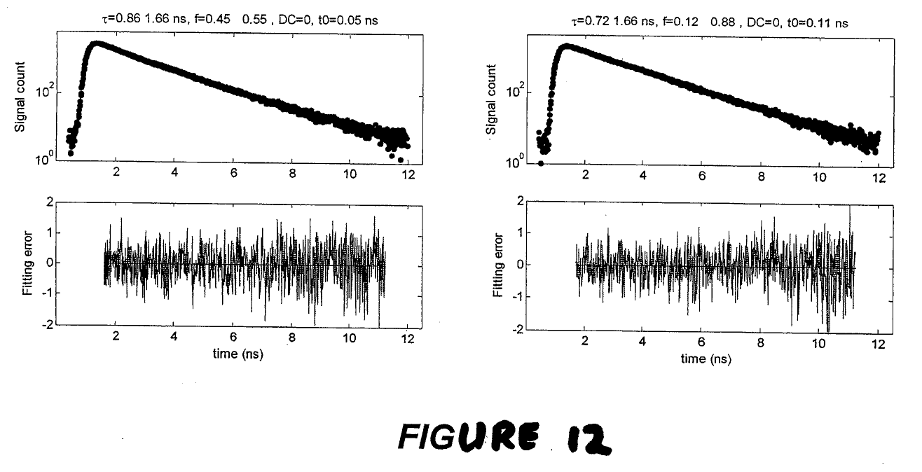

A typical example demonstrating time scales is shown in FIG. 9. This figure shows a graph having a decay curve 10 that corresponds to the F₀(t) term in Equation (3) for dual fluorescence lifetimes 1.0 and 1.8 ns. The light diffusion [DE: D(\vec{r},t)=H(\vec{r}ₛ−\vec{r}_{f},t)*E(\vec{r}−\vec{r}_{f}−\vec{r}_{d},t)] curve 12 is obtained using Equation (23) for a constituent located at depth 8.5 mm inside a homogeneous slab phantom with thickness s=25 mm and optical properties μₐ=0.03 mm⁻¹, μₛ′=1.0 mm⁻¹ (typical values for mouse tissue). The DE curve 12 is the convolution of H(\vec{r}ₛ−\vec{r}_{f},t) and E(\vec{r}_{f}−\vec{r}_{d},t) in Equation (3) for reflection geometry with source-detector separation of 3 mm. These parameters are typically used in Optix™, a commercially available small animal fluorescence imaging system manufactured by ART Advanced Research Technologies, Inc, St-Laurent, Quebec. The IRF curve 20 shown in FIG. 9 is a measured S(t) using Optix™ platform. Curve 14 represents the convolution of fluorescence decay F₀(t) 10, light diffusion curve 12 and system IRF curve 20, e.g. a simulation of a time-resolved signal typically measured for the constituent having lifetime decay curve 10 using Optix™.

In reviewing FIG. 9, it can be appreciated that the falling slope of curve 14 is similar to that of the fluorescence decay 10. However, there is a time shift between curve 14 and system IRF 20 (curve 16). Indeed, if curve 16 is shifted by Δt (shown as curve 18), it overlaps with curve 14, especially the falling slope. This implies that the effect of light diffusion is equivalent to a time delay of the fluorescence signal. Based on this finding, Equation (3) can be simplified to:

F(t)≈F₀(t)*δ(Δt)*S(t). Eq. (25)

There should be a scaling factor between this approximation, Equation (25), and its exact counterpart, Equation (3). The scaling factor is neglected since it does not affect the results of interest in the present example, but the scaling factor could be considered for other applications. By comparing time-resolved signals against Equation (25), fluorescence lifetimes can be estimated using the conventional procedure through curve fitting, e.g., least square, or other minimization method. In this way, use of complex model of light propagation in tissue and knowledge of tissue optical properties is circumvented, which is of particular interest since they are not available in many practical applications.

For practical purposes, the method discussed herein is appropriate when diffusion does not significantly change the falling slope of a constituent decay. In practice, it applies to applications when constituents are not too deep inside a tissue if reflection configuration is used to acquire data. In other words, the optical path of the excitation and constituent signal should not be too long. Experience shows that, if a fluorophore is inside, for example, a mouse, the proposed method is applicable. If a fluorophore locates several centimeters deep inside a tissue, for example within a human breast, the proposed method requires further adaptation.

Through lifetime fitting, amplitude of each constituent in a mixture Aᵢ is also determined. The relative or normalized amplitude αᵢ is calculated by:

$${α}_{i} = \frac{{A}_{i}}{{\sum }_{i} {A}_{i}} \qquad Eq . ( 26 )$$

The values of αᵢ and τᵢ can be used to determine the fraction contribution (fᵢ) of each decay constituent to the total steady-state (CW) intensity:

$${f}_{i} = \frac{{A}_{i} {τ}_{i}}{{\sum }_{j} {A}_{j} {τ}_{j}} = \frac{{α}_{i} {τ}_{i}}{{\sum }_{j} {α}_{j} {τ}_{j}} \qquad Eq . ( 27 )$$

The terms αᵢτᵢ are proportional to the area under the decay curve for each decay time, i.e., CW intensity. The relation between the relative amplitude αᵢ and fraction contribution fᵢ can also be worked out:

$${α}_{i} = \frac{{f}_{i}}{{f}_{i} + {τ}_{i} {\sum }_{j \neq i}^{ } \frac{{f}_{j}}{{τ}_{j}}} \qquad Eq . ( 28 )$$

The various aspects of lifetime estimation disclosed herein may be used to estimate multiple fluorescence lifetimes of unknown time-resolved signal from biological tissue. In a first aspect, the effect of light diffusion in the tissue is simplified as a time delay. Based on this simplification, the lifetimes and the constituent fractions of multiple fluorescence decays can be estimated using traditional data lifetime fitting procedures, e.g., least-square minimization between measured data and fluorescence decay model. In a second aspect, the contribution fractions of multiple decays in an unknown time-resolved fluorescence signal can be estimated through data fitting if the time-resolved signal of single decay constituents (time-resolved reference signals) is also measured. In this way, the number of fitting parameters is reduced and more information from the unknown time-resolved signal is directly used.

### Experimental Results of the Qualitative and Quantitative Analysis in Liquid Phantom

A liquid phantom was produced by mixing 10% Liposyn II (available from Abbott Laboratories, Montreal, Quebec, Canada), demineralized water and India ink (available from Idee Cadres, Laval, Quebec, Canada). Approximately 250 ml of the liquid was poured into a rectangular container having the dimensions 7×7×6 cm³. The quantity of each constituent was selected using a predetermined recipe to ensure that the optical properties are similar to those of mouse tissue (i.e., μₛ′=1.0 mm⁻¹, μₐ=0.03 mm⁻). This recipe was verified using the SOFTSCAN™ diffusion optical tomography device for breast imaging, produced by ART Advanced Research Technologies, Inc. Constituents in the form of fluorophore inclusions (liquid mixtures of Cy5.5 and Atto680 at various ratios confined in small cylindrical containers having a diameter of approximately 2 mm were placed at 4 mm below the phantom surface.

Data was acquired using an optical imaging system like that described above in conjunction with FIG. 1. In particular, the system used in the experiment was an OPTIX™ imaging system produced by ART Advanced Research Technologies, St-Laurent, Quebec, Canada. A pulsed diode laser (PDL) was used as a light source, and a photomultiplier tubes (PMT) coupled with a time correlated single photon counting (TCSPC) system used as a fluorescence signal detector. A combination of filters was installed in the system for fluorescence measurements. A translation stage and galvanometric mirrors enabled raster scanning along x and y directions for imaging. Typically, for a GFP experiment, a 470 nm laser is used and the average laser power is kept at about 0.5 mW. For the phantom experiment, however, a 670 nm laser was used and the average laser power kept at about 1.5 mW. Actual laser power delivered to the imaging target was adjusted by a computer-controlled variable neutral density filter wheel.

A resulting fluorescence image is shown in FIG. 2. The bright spots in the image correspond to a Cy5.5/Atto680 mixture with the following ratios: 100:0, 90:10, 50:50, 10:90 and 0:100. The rightmost dark spot shown in FIG. 2 is the background signal, which is attributed mainly to the autofluorescence of the liquid phantom.

Then, eighteen mice were imaged with GFP labeled brain tumors. In addition, one reference mouse was also imaged. The number of GFP labeled brain tumor cells injected was different from mouse to mouse. The time for performing the optical imaging varied from eight to sixteen days after the tumor cells were injected.

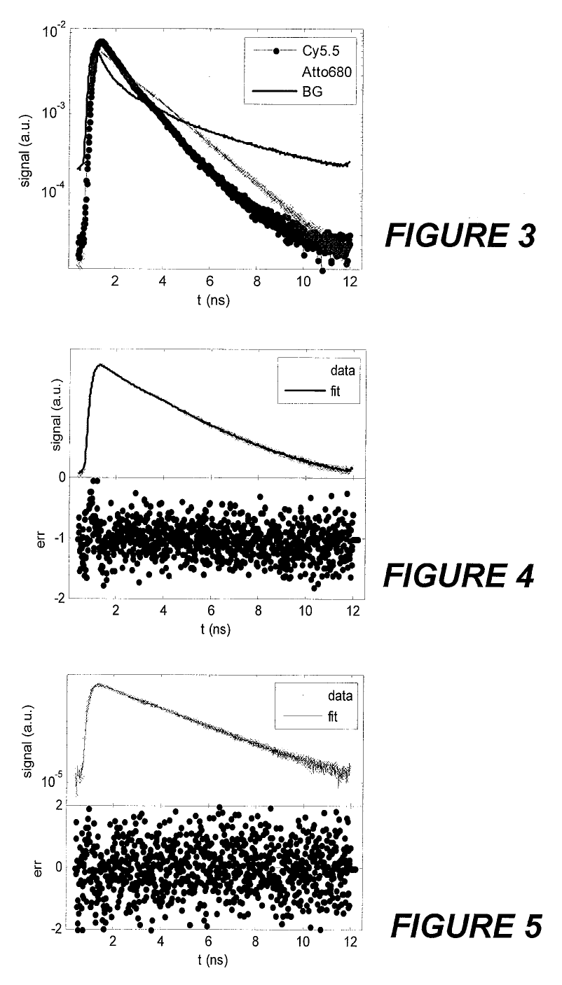

The measured raw fluorescence signal from the liquid phantom, as shown in FIG. 2, came from different samples. The bright spots in the FIG. 2 are marked from left to right as A, B, C, D, E and F. Each of the signals may contain three constituents: Cy5.5 fluorescence, Atto680 fluorescence, and the background mainly attributed to autofluorescence from the liquid. The temporal signatures of these signals are shown in FIG. 3. The background noise time-resolved reference signal is obtained directly from the rightmost dark spot F, where no Cy5.5 or Atto680 is present. The Cy5.5 time-resolved reference signal is obtained from the leftmost spot A with background noise and Atto680 absent. The Atto680 time-resolved reference signal is obtained similarly from the 100% Att680 sample (second spot from right, E) with background noise removed. All of these three reference signals are normalized according to equation (12).

Following the approach described above, the raw fluorescence signals from all of the samples shown in FIG. 2 were decomposed using the three reference signals shown in FIG. 3. The results are shown below in Table 1.

TABLE 1

| Sample | f′_{Cy5.5} | f′_{Atto680} | f′_{BG} |
|---|---|---|---|
| A | 0.75 | 0 | 0.25 |
| B | 0.66 | 0.21 | 0.13 |
| C | 0.40 | 0.43 | 0.17 |
| D | 0.11 | 0.68 | 0.21 |
| E | 0 | 0.89 | 0.11 |
| F | 0 | 0 | 1 |

As an example, the original signal from sample D and the fitted signal based on decomposition together with the error distribution are displayed in FIG. 4. As shown, the figure indicates that the decomposition is successful. The fittings for other samples are similar to FIG. 4. Since the origins of the signals are different, without considering the diffusion terms D(\vec{r}) and D(\vec{r}₁), the results shown in Table 1 provide qualitative information. Even then, the decomposition results correlate relatively well with the experimental distributions. If a constituent is not contained in a sample, the fitted “pseudo” fractional contribution fᵢ′ is zero, such as the Atto680 fraction in sample A, Cy5.5 fraction in sample E, and the Atto680 and Cy5.5 fractions in sample F. On the other hand, if a constituent is contained in a sample, the fitted “pseudo” fractional contribution fᵢ′ is nonzero.

With regard to the origins of the fluorescence signal, the Cy5.5 and Atto680 fluorescence comes from their mixture at 4 mm deep inside the liquid phantom, and the background signal comes mainly from the region near the phantom surface. Based on the results shown in Table 1, this can be taken a step further. Since the origins of the Cy5.5 and Atto680 fluorescence are similar, one can assume that the diffusion effects on them are the same. The fractional contribution of the Cy5.5 and the Atto680 fluorescence to the mixture can then be deduced. Shown in Table 2 are the results deduced from the “pseudo” fractional contribution f_{Cy5.5}′, f_{Atto680}′ listed in Table 1. In addition to the fractional contributions, the corresponding fluorophore quantity fractions C_{Cy5.5}, C_{Atto680} are also computed based on equation (22). As can be seen, they are close to the true values used in the phantom.

TABLE 2

| Sample | f′_{Cy5.5} | f′_{Atto680} | C_{Cy5.5} | C_{Atto680} |
|---|---|---|---|---|
| A | 1 | 0 | 1 | 0 |
| B | 0.76 | 0.24 | 0.89 | 0.11 |
| C | 0.48 | 0.52 | 0.70 | 0.30 |
| D | 0.14 | 0.86 | 0.29 | 0.71 |
| E | 0 | 1 | 0 | 1 |

In addition to the three-constituent analysis, one can also perform a two-constituent analysis for the Cy5.5/Atto680 signal mixture. By removing background noise from the unknown time resolved signals originating from sample A, B, C, D and E, there remains only a Cy5.5/Atto680 fluorescence signal. By applying the present method to these signals using pure Cy5.5 and Atto as time-resolved reference signals, it is possible to obtain the fractional contributions as well as the fluorophore quantity fractions. The decomposition process of sample D is shown in FIG. 5, along with the fitting errors. Similar to the three-constituent decomposition, the fitting errors are uniformly distributed, indicating that the decomposition is accurate. The results for the samples are shown in Table 3, and agree with the results obtained using three-constituent analysis.

TABLE 3

| Sample | f′_{Cy5.5} | f′_{Atto680} | C_{Cy5.5} | C_{Atto680} |
|---|---|---|---|---|
| A | 1 | 0 | 1 | 0 |
| B | 0.71 | 0.29 | 0.86 | 0.14 |
| C | 0.46 | 0.54 | 0.68 | 0.32 |
| D | 0.14 | 0.86 | 0.29 | 0.71 |
| E | 0 | 1 | 0 | 1 |

### Experimental Results of the Qualitative and Quantitative Analysis In Vivo

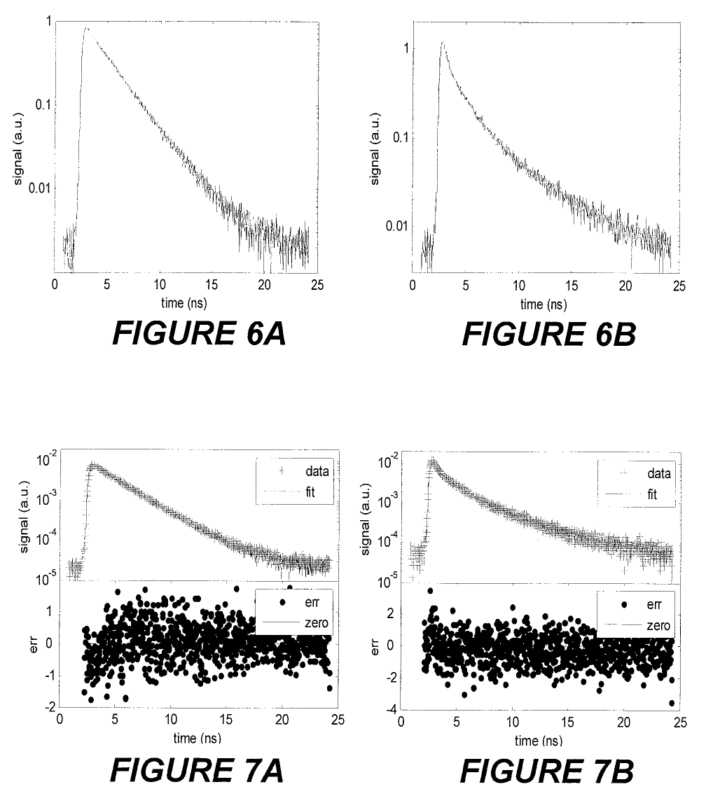

During in vivo GFP experiments, the measured signal can be assumed to be the combination of the pure GFP fluorescence and the background noise. The two corresponding time-resolved reference signals are shown, respectively, in FIGS. 6A and 6B. The time-resolved GFP signal of FIG. 6A is obtained from a mouse after fifteen days following an injection of a large number of tumor cells with the background noise removed. The time-resolved reference signal for background noise shown in FIG. 6B is from a reference mouse. The complicated temporal decay profile indicates that the background noise is a combination of several constituents.

FIGS. 7A and 7B respectively show two typical examples of decomposition of an unknown composite fluorescence signal using the time-resolved reference signal for GFP and time-resolved reference signal for background noise shown in FIGS. 6A and 6B. The equally distributed fitting error also shown in the FIGS. 7A and 7B indicates that the decomposition has converged well.

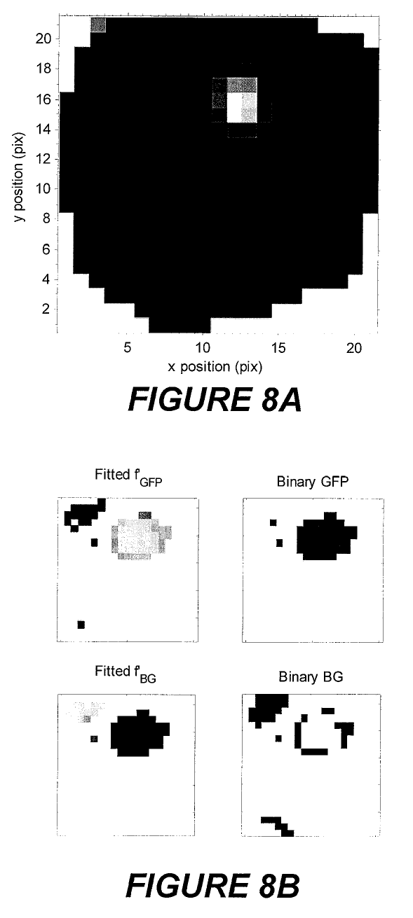

Since the origins of the GFP and background noise time-resolved signals are different, the decomposition results only provide “pseudo” fractional contribution fᵢ′ of the GFP constituent. Based on that information, a binary image can be obtained to indicate if GFP is present in the imaged location. In FIGS. 8A and 8B, typical fluorescence images are shown that have been processed using the method of the present invention. The intensity image of FIG. 8A shows the mixed signal of GFP fluorescence and background noise. The fraction images of FIG. 8B show the “pseudo” fraction fᵢ′ from decomposition for each of the fitted GFP signal fraction, the fitted background signal, the binary GFP signal fraction and the binary background signal (as labeled in the figure). The binary images indicate if a pixel contains GFP or background noise.

Example of Lifetime Estimation with Simulated Data

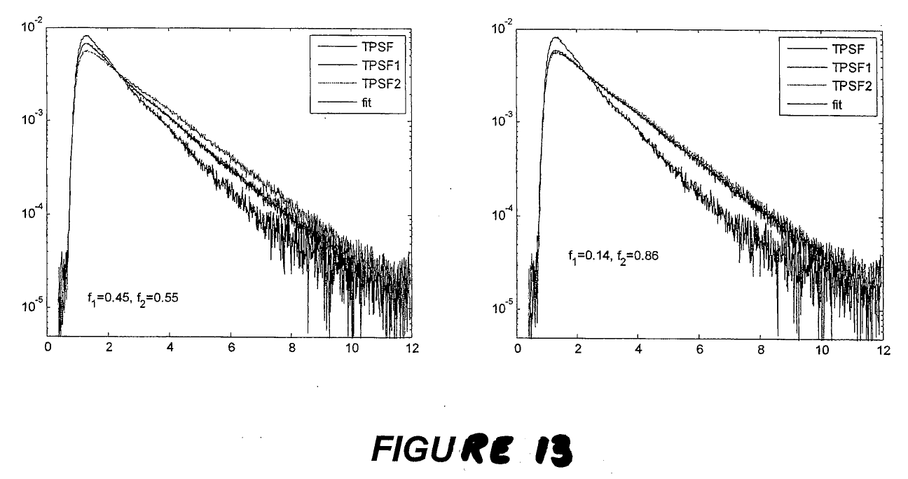

Two examples of fluorescence lifetime fitting based on simulated data are shown in FIG. 10. In both of examples, the data corresponds to fluorescence signals measured under reflection geometry using Optix™ with a source-detector separation of 3 mm for a mixture of two fluorophores submerged inside a 20 mm thick slab with optical properties μₐ=0.03 mm⁻¹, μₛ′=1.0 mm⁻¹, typical values of mouse tissue. The lifetimes of the two fluorophores are 1.0 ns and 1.8 ns. On the left panel of FIG. 10, the fluorophore mixture is positioned at 1.2 mm below the slab surface, and the fractions of the two fluorophores are 0.50/0.50. A DC count of 20 is included in the signal. On the right panel, the inclusion is located at 5.5 mm deep inside the phantom. The fractions of the fluorophores with 1.0 ns and 1.8 ns lifetime are 25% and 75%, respectively. No DC is added for this case. The signals are generated using Equation (3). Fitted values are marked at the tops of the two graphs. They are very close to the true values. The fitting error and fitting goodness shown in the two bottom panels indicate that the fittings for both examples are very good.

The results of the lifetime estimation for the same data are shown in FIG. 11. Curves 30 and 32 are simulated signals of single fluorescence decay with lifetime 1.0 ns and 1.8 ns, respectively. Curves 34 are simulated signals from fluorophore mixtures, and curves 36 are the fitting results based on the two single decays. As can be seen from FIG. 11, curves 34 and 36 closely approximate each other with respectively fitting parameters f₁=0.47; f₂=0.53 and f₁=0.20; f₂=0.80. Notably, fitted fractions are close not only to the true values, but also to the fitted fraction previously obtained.

### Example of Lifetime Estimation in Phantom Liquid

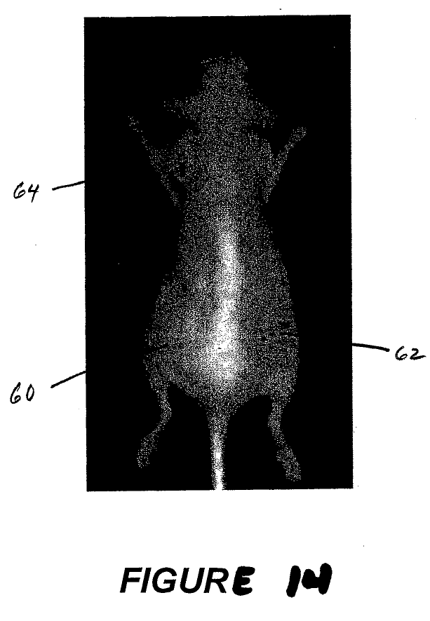

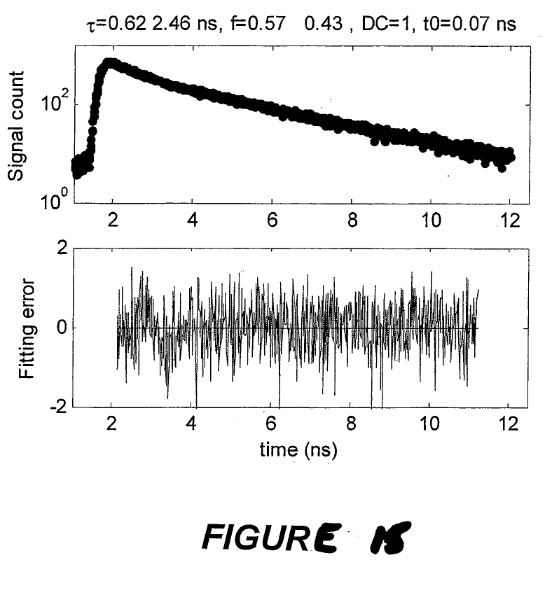

Shown in FIG. 12 and FIG. 13 are some results based on the liquid phantom experiment previously described. In this particular experiment, the fluorophore inclusion was a mixture of Cy5.5 and Atto680 liquid confined in a small tube container (diameter ˜2 mm). The inclusion was placed at 4 mm below the phantom surface. Data was acquired using the Optix™ instrument mentioned above. On the left and right panels of FIG. 12 and FIG. 13, the decay curves correspond to Cy5.5/Atto680 mixtures of 0.50/0.50 and 0.10/0.90 by fraction, respectively.

FIG. 12 shows the lifetime estimation results obtained by modeling the light propagation as a time-delay during lifetime estimation performed by means of convolution of system IRF, and FIG. 13 shows the results for lifetime estimation by comparing an unknown time-resolved signal of the mixture of constituents and comparing with time-resolved reference signals of each separate constituent. Fitted lifetimes and decay fractions are inserted as text in the graphs. Regarding FIG. 12, the fitted lifetimes for both cases are 0.8 ns and 1.7 ns, close the values obtained using single dye samples, 0.9 ns and 1.7 ns. In addition, the fitting errors shown in the bottom panels of FIG. 12 indicate the fitted decay curves match the data without any bias. The fitted fractions of the two examples are consistent using the two analysis (0.45/0.55 and 0.12/0.88 versus 0.45/0.55 versus 0.14/0.86), and close to their true values (0.50/0.50 and 0.10/0.90).

### Example of Lifetime Estimation for In Vivo Data

In this experiment, two fluorescent dyes and their mixture were injected subcutaneously in three locations of a living mouse, left and right hips, and left shoulder, as shown in FIG. 14 by the fluorescence image acquired by the Optix™ instrument. The lower-left spot 600 (left hip) is the single dye with a short lifetime. The lower-right spot 620 (right hip) is the single dye with a long lifetime. The upper-left spot 640 (left shoulder) is the 0.50/0.50 mixture of the two dyes.

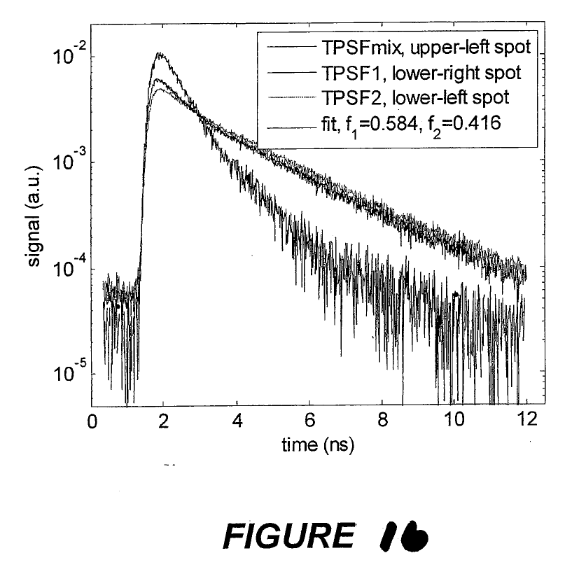

The fluorescence signals from the three locations were estimated using the disclosed aspects—namely the modeling of light propagation as a time-delay and followed by comparing the time-resolved measured signal with a simulated convolution IRF system, and the other method of comparing the time-resolved signal of the mixture with time-resolved reference signals of each constituent. Shown in FIG. 15 and FIG. 16 are the estimation results for the mixture (R3: upper-left spot) using the first and second aspects respectively. Similar to the previous figures, the estimated lifetime and decay fractions are shown in the graphs by description text. Estimated fluorescence lifetimes 0.62 ns and 2.46 ns are close to that obtained from signals emanating from the other two regions (R1: lower-left spot; and R2: lower right spot) by single lifetime fitting (0.65 ns and 2.43 ns). The estimation error shown in the bottom panel of FIG. 15 indicates the good fitting quality. Estimated fractions using the two approaches are close to each other (0.57/0.43 versus 0.58/0.42), and close to the true values 0.50/0.50.

Examples based on simulation, phantom data, and in vivo experiments for lifetime and constituent fraction estimation of constituent decays demonstrate the applicability of the present invention. Furthermore, the principle of the proposed methods can be extended to multiple constituent decays. In addition, the multiple decays can come from different fluorescent dyes (as the examples shown here), or from the same dye at different environments since fluorescence lifetime changes with its microenvironment.

While the invention has been shown and described with reference to preferred embodiments thereof, it will be recognized by those skilled in the art that various changes in form and detail may be made therein without deviating from the spirit and scope of the invention as defined by the appended claims.

1. A method for decomposing a test sample into one or a plurality of constituents, the method comprising:
optically imaging the test sample to obtain a corresponding unknown time-domain resolved signal; and
decomposing the unknown time-domain resolved signal by comparing the unknown time-domain resolved signal with time-domain resolved reference signals.

2. A method according to claim 1, wherein the time-domain resolved reference signals are individually recorded for each of the constituents in a reference sample using the time-domain optical imaging apparatus;

3. A method according to claim 1, further comprising analyzing decomposed unknown time-domain resolved signal for determining constituents present in the test sample.

4. A method according to claim 1, further comprising performing a quantitative analysis for determining relative fractional contributions of the constituents in the test sample.

5. A method according to claim 1 wherein decomposing the unknown time-resolved signal comprises a least squares fitting of the unknown time-resolved signal to the time-resolved reference signals.

6. A method according to claim 1 wherein one of the constituents is a known fluorophore.

7. A method according to claim 6 wherein another constituent is an autofluorescent medium.

8. A method according to claim 6 wherein another consistuent is a second known fluorophore.

9. A method according to claim 4 further comprising determining a relative quantity of at least one of the constituents.

10. A method according to claim 9, wherein determining the relative quantity of at least one of the constituents comprises locating the at least one constituent at substantially the same position in the test sample and in the corresponding reference sample.

11. A method according to claim 9, wherein determining the relative quantity of at least one of the constituent comprises individually determining the position of each of the at least one constituent in the corresponding reference sample and in the test sample, and the optical properties of the reference sample and test sample.

12. A method according to claim 9 wherein the reference samples and the test sample are in vitro.

13. A method according to claim 9 further comprising measuring a relative steady-state fluorescence intensity ratio of two of the constituents, and determining a fluorophore quantity fraction Ci for each of the constituents from an estimated fluorescence signal intensity fraction fᵢ for each of the constituents on the reference sample.

14. A method for estimating multiple fluorescence lifetime of one or a plurality of constituents of an in vivo test sample, the method comprising:
estimating lifetime of the one or the plural constituents using lifetime fitting procedures by handling effect of light diffusion in the test sample as a time delay; and
estimating contribution fractions of multiple decays through data fitting with known individual decay of constituents.
